(19) United States
(12) Patent Application Publication
(10) Pub. No.: US 2025/0229219 A1
(43) Pub. Date: Jul. 17, 2025

(54) CARBON DIOXIDE CAPTURE AGENT CONTAINING TWO TYPES OF AMINE COMPOUNDS AND CARBON DIOXIDE CAPTURE METHOD USING THE SAME

(71) Applicant: KOREA INSTITUTE OF ENERGY RESEARCH, Daejeon (KR)

(72) Inventors: Sung Chan NAM, Daejeon (KR); Jong Tak JANG, Daejeon (KR); Sung Hoon LEE, Sejong-si (KR); Il Hyun BAEK, Daejeon (KR)

(73) Assignee: KOREA INSTITUTE OF ENERGY RESEARCH, Daejeon (KR)

(21) Appl. No.: 18/763,296

(22) Filed: Jul. 3, 2024

(30) Foreign Application Priority Data
Jan. 16, 2024 (KR) 10-2024-0006785

(51) Int. Cl. B01D 53/14; B01D 53/62; B01D 53/78; B01D 53/96

(52) U.S. Cl. CPC B01D 53/1493; B01D 53/1425; B01D 53/1475; B01D 53/62; B01D 53/78; B01D 53/96; B01D 2252/20405; B01D 2252/20431; B01D 2252/20447; B01D 2252/20484; B01D 2252/504; B01D 2257/504

(57) ABSTRACT

The present invention relates to a carbon dioxide capture agent containing two types of amine compounds and a carbon dioxide capture method using the same, by which not only an effective and economically sustainable CO₂ capture process can be performed but also an improved reaction rate is achieved.

### BACKGROUND OF THE INVENTION

### Field of the Invention

The present invention relates to a carbon dioxide capture agent containing two types of amine compounds and a carbon dioxide capture method using the same.

### Description of the Related Art

Since the industrial revolution began in the 1750s, the concentration of greenhouse gases in the atmosphere has begun to increase rapidly as large amounts of greenhouse gases have been continuously emitted. Carbon dioxide, which accounts for most of the emitted greenhouse gases, causes global warming and climate change, so it is necessary to make efforts to reduce the emissions of carbon dioxide in industry. In particular, coal-fired power generation, the CO₂ emission from which accounts for about 30% of CO₂ emissions in all energy-related businesses, is known to be the biggest single source of CO₂ emissions. Global CO₂ emissions from coal-fired power plants reached a record 9.7 Gt in 2021, which is a value increased by 100 Mt or more from the previous peak in 2018. To get the net zero scenario on track by 2050, it is necessary to reduce emissions from coal-fired power plants by an average of about 8% per year by 2030.

To reduce emissions in industry, post-combustion CO₂ capture technology, in which CO₂ from exhaust gases is captured and released into the atmosphere, is widely used. Currently available CO₂ capture technologies include adsorption, physical/chemical absorption, membrane separation, bioremediation, and cryogenic separation.

Among these, the chemical absorption process using aqueous amine solutions is a matured process that has been developed since the 1930s, and accounts for 60% or more of the carbon capture market share because of its ease of operation, fast CO₂ absorption rate, high absorption capacity, and recycling ability. Compared to other CO₂ capture processes, the chemical absorption process is a reasonable technology that can extract CO₂ directly from flue gases, thus is relatively inexpensive and can be easily applied to current power plants. Accordingly, the amine-based chemical absorption process is a method first to be considered for large-scale CO₂ capture in coal-fired power plants and the like.

### SUMMARY OF THE INVENTION

The present invention has been devised to solve the above-mentioned problems, and an embodiment of the present invention provides a carbon dioxide capture agent containing two types of amine compounds and a carbon dioxide capture method using the same.

The technical object to be achieved by the present invention is not limited to the technical object mentioned above, and other technical objects that are not mentioned will be clearly understood by those skilled in the art to which the present invention pertains from the description below.

As a technical means for achieving the above-described technical object, an aspect of the present invention provides a carbon dioxide capture agent containing an amine mixture, in which the amine mixture contains a first amine compound including a tertiary amine; and a second amine compound including a secondary amine.

The first amine may be one or more selected from the group consisting of 3-dimethylamino-1-propanol (3DMA1P), N, N-methyl diethanolamine (MDEA), triethanolamine (TEA), triisopropanolamine (TIPA), and any combination thereof.

The first amine may be 3-dimethylamino-1-propanol (3DMA1P).

The second amine may be one or more selected from the group consisting of piperazine (PZ), propylamine, dipropylamine, butylamine, dibutylamine, isobutylamine, 1,2-dimethyl propylamine, hexylamine, N, N-dimethyl allylamine, dimethylamino ethylamine, 1,3-diamino propane, methylamino propylamine, N-aminoethyl morpholine, iminobispropylamine, 2-pipecoline, 2,4-lupetidine, N-amino-4-pipecoline, 2-piperidine ethanol, 4-piperidinol, N-methyl benzylamine, dibenzylamine, phenethylamine, pyrazine, 2-methyl pyrazine, 2-methyl piperazine, 2,3-lutidine, 2-methyl-4-ethyl pyridine, 4-alkyl pyridine, picolinic acid, 2-aminonicotinic acid, 3-amino pyridine, 3-decyloxy propylamine, and any combination thereof.

The second amine may be piperazine (PZ).

The amine mixture may contain the first amine compound and the second amine compound at a weight ratio of 2 to 15:1.

The content of the amine mixture may be 35% to 45% by weight based on 100% by weight of the total amount of the carbon dioxide capture agent.

As a technical means for achieving the above-described technical object, another aspect of the present invention provides a carbon dioxide capture method including a step of preparing a liquid absorbent containing an amine mixture; a step of bringing the liquid absorbent into contact with a gas or liquid containing carbon dioxide; a step of absorbing carbon dioxide from the gas or liquid; and a step of desorbing the carbon dioxide, in which the amine mixture contains a first amine compound including a tertiary amine and a second amine compound including a secondary amine.

The first amine compound may be 3-dimethylamino-1-propanol (3DMA1P), and the second amine compound may be piperazine (PZ).

The amine mixture may contain the first amine compound and the second amine compound at a weight ratio of 2 to 15:1.

The content of the amine mixture may be 35% to 45% by weight based on 100% by weight of the total amount of the liquid absorbent.

The absorption step may be performed at a temperature of 300 to 330 K.

The absorption step may be performed at a pressure of 1 to 10 kPa.

The step of desorbing may be performed at a temperature of 380 to 410 K.

The step of desorbing may be performed at a pressure of 90 to 100 kPa.

### BRIEF DESCRIPTION OF THE DRAWINGS

FIG. 1 is a flowchart illustrating a carbon dioxide capture method using a carbon dioxide capture agent according to an exemplary embodiment of the present invention;

FIG. 2 is a schematic diagram illustrating a gas-liquid equilibrium experimental apparatus used for the CO₂ equilibrium solubility experiment and absorption rate measurement of a carbon dioxide capture agent according to an exemplary embodiment of the present invention;

FIG. 3 illustrates the results of measuring the CO₂ equilibrium solubility value at a temperature of 313 K of a carbon dioxide capture agent according to an exemplary embodiment of the present invention and carbon dioxide capture agents according to other literatures;

FIG. 4A illustrates the results of measuring the CO₂ equilibrium solubility value at a temperature of 313 K of a carbon dioxide capture agent according to an exemplary embodiment of the present invention;

FIG. 4B illustrates the results of measuring the CO₂ equilibrium solubility value at a temperature of 393 K of a carbon dioxide capture agent according to an exemplary embodiment of the present invention;

FIG. 5 illustrates the results of measuring the cyclic capacity of a carbon dioxide capture agent according to an exemplary embodiment of the present invention;

FIG. 6 is a schematic diagram illustrating a wetted wall column (WWC) apparatus used to measure the overall mass transfer coefficient of a carbon dioxide capture agent according to an exemplary embodiment of the present invention;

FIG. 7 illustrates the results of measuring the CO₂ absorption flux at a temperature of 313 K and various partial pressures of a carbon dioxide capture agent according to an exemplary embodiment of the present invention;

FIG. 8 illustrates the results of measuring the overall mass transfer coefficient (K_{G}) at a temperature of 313 K of a carbon dioxide capture agent according to an exemplary embodiment of the present invention;

FIG. 9 is a schematic diagram illustrating a differential reaction calorimeter (DRC, Setaram) that measures the quantity of heat generated when CO₂ reacts with a carbon dioxide capture agent according to an exemplary embodiment of the present invention;

FIG. 10 illustrates the results of measuring the heat of absorption at a temperature of 313 K of a carbon dioxide capture agent according to an exemplary embodiment of the present invention;

FIG. 11 illustrates the results of measuring the values of sensible heat, latent heat, and heat of absorption of a carbon dioxide capture agent according to an exemplary embodiment of the present invention;

FIG. 12 illustrates the results of measuring the relative heat duty of a carbon dioxide capture agent according to an exemplary embodiment of the present invention when the Q_{reg} value of MEA 30 is regarded as 100;

FIG. 13 is a schematic diagram illustrating a batch reactor used for sampling of a carbon dioxide capture agent according to an exemplary embodiment of the present invention;

FIG. 14 illustrates molecular structures in which carbon is assigned a number to indicate the chemical species of the corresponding peaks in the 13C NMR spectrum of a carbon dioxide capture agent according to an exemplary embodiment of the present invention;

FIG. 15 illustrates peaks in the 13C NMR spectrum for a 3DMA1P-PZ-H₂O—CO₂ system; and

FIG. 16 illustrates the results of measuring the concentrations of products in a 3DMA1P-PZ-H₂O—CO₂ system depending on CO₂ loading.

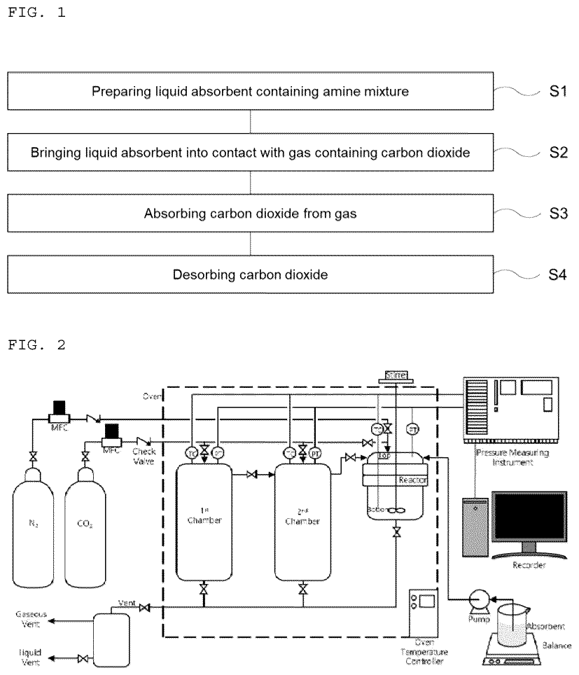

### DETAILED DESCRIPTION OF THE PREFERRED EMBODIMENTS

Hereinafter, the present invention will be described in more detail. However, the present invention may be implemented in various different forms, is not limited to the embodiments described herein, and is only defined by the claims to be described later.

Additionally, the terms used in the present invention are only used to describe specific embodiments and are not intended to limit the present invention. Singular expressions include plural expressions unless the context clearly dictates otherwise. Throughout the specification of the present invention, ‘including’ a certain constituent means that other constituents may be further included rather than excluding other constituents, unless specifically stated to the contrary.

A first aspect of the present disclosure provides a carbon dioxide capture agent containing an amine mixture.

Hereinafter, the carbon dioxide capture agent according to the first aspect of the present disclosure will be described in detail.

In an exemplary embodiment of the present disclosure, the carbon dioxide capture agent may contain an amine mixture.

The amine mixture may contain a first amine compound and a second amine compound.

The first amine compound may include a tertiary amine.

The first amine may be one or more selected from the group consisting of 3-dimethylamino-1-propanol (3DMA1P), N, N-methyl diethanolamine (MDEA), triethanolamine (TEA), triisopropanolamine (TIPA), and any combination thereof.

The first amine may preferably be 3-dimethylamino-1-propanol (3DMA1P).

Amines are classified according to the number of amine groups, and the most widely commercialized amine in the configuration of carbon dioxide capture agents is monoethanolamine (MEA), a primary amine, which has advantages of high absorption rate and low price. However, primary amines have disadvantages of having a small absorption capacity and requiring a large quantity of energy for regeneration since the primary amines follow the mechanism of forming stable carbamates. Secondary amines have a fast absorption rate but have a small absorption capacity and require a large quantity of energy for regeneration. Tertiary amines have a large absorption capacity and require a small quantity of energy for regeneration but have a slow absorption rate.

Therefore, in the present invention, by preparing a capture agent containing an amine mixture of these amines rather than a single amine, the disadvantages of carbon dioxide capture agents containing single amines are complemented and effects of having superior CO₂ absorption and desorption performance, heat of reaction, and energy consumption are realized. In particular, carbon dioxide capture agents based on tertiary amines have an effect of exhibiting more improved energy efficiency than capture agents based on primary amines or secondary amines.

Research results have been reported that 3-dimethylamino-1-propanol (3DAM1P) among these tertiary amines is more advantageous for CO₂ capture than the commonly used tertiary amine methyldiethanolamine (MDEA). N. El Hadri (EL HADRI, Nabil, et al. Aqueous amine solution characterization for post-combustion CO₂ capture process. Applied Energy, 2017, 185:1433-1449.) is a literature that investigated the CO₂ loading values and heat of absorption of 30 amines, demonstrating that 3DMA1P has greater potential for CO₂ capture than MDEA in that the CO₂ loading values of MDEA and 3DMA1P are 0.74 and 0.85 (molCO₂/molamine) and the values of heat of absorption thereof are as similar as −52.51 and −54.55 (H; kJ/mol of CO₂). According to Liu (LIU, Sen, et al. Experimental evaluation of highly efficient primary and secondary amines with lower energy by a novel method for post-combustion CO₂ capture. Applied energy, 2019, 233:443-452.), the rGm (molar Gibbs energy change of proton combination with amine, kJ/mol) and rHm (molar reaction enthalpy of protonated amine dissociation into amine and proton, kJ/mol) values of 11 amines have been calculated. The rGm values of the compared tertiary amines, MDEA, DEEA, N, N-dimethylethanolamine (DMEA), and 3DMA1P, are −49.15, −56.57, −53.26, and −54.75, respectively and the rHm values thereof are 40.93, 43.25, 41.25, and 39.89, respectively, showing that 3DMA1P is the most ideal amine among the compared tertiary amines. In addition, 3DMA1P has the largest cyclic capacity and is expected to have the most favorable energy efficiency among the compared amines. According to Kadiwala (KADIWALA, Salim. Absorption Rates of CO₂ in Aqueous and Non-Aqueous Amine Solutions and Solubility of CO₂ in Aqueous Piperazine Solution. 2008. PhD Thesis. University of Regina.), 3DMA1P has a higher reaction rate with CO₂ than MDEA.

Structural properties of molecules can determine the performance of amines for CO₂ capture and explain the high absorption ability of 3DMA1P. The Hadri literature indicates that the tertiary amine 3DMA1P having a four carbon chain length between two functional groups has faster reaction kinetics and a lower heat of CO₂ absorption than a parallel amine having two carbon chains. The Hadri literature also indicates that CH₂CH₃ linked to a nitrogen atom is more beneficial to CO₂ solubility than CH₃ of the same carbon chain length in tertiary amines.

The absorption rate of 3DMA1P may be faster than other tertiary amines, but because of the nature of tertiary amines, 3DMA1P has significantly slower results than primary and secondary amines and diamines. Accordingly, it is necessary to add primary and secondary amines to improve the absorption rate of 3DMA1P.

Therefore, the present invention may contain an amine mixture in which a first amine compound, which is a tertiary amine, and a second amine compound, which is a secondary amine, are mixed.

The second amine may be one or more selected from the group consisting of piperazine (PZ), propylamine, dipropylamine, butylamine, dibutylamine, isobutylamine, 1,2-dimethyl propylamine, hexylamine, N, N-dimethyl allylamine, dimethylamino ethylamine, 1,3-diamino propane, methylamino propylamine, N-aminoethyl morpholine, iminobispropylamine, 2-pipecoline, 2,4-lupetidine, N-amino-4-pipecoline, 2-piperidine ethanol, 4-piperidinol, N-methyl benzylamine, dibenzylamine, phenethylamine, pyrazine, 2-methyl pyrazine, 2-methyl piperazine, 2,3-lutidine, 2-methyl-4-ethyl pyridine, 4-alkyl pyridine, picolinic acid, 2-aminonicotinic acid, 3-amino pyridine, 3-decyloxy propylamine, and any combination thereof.

The second amine may preferably include piperazine (PZ).

Piperazine, a cyclic compound containing two secondary amine groups, exhibits higher resistance to deterioration and corrosion than existing alkanol amines such as monoethanolamine, has a low volatility, exhibits favorable CO₂ absorption ability, requires a small quantity of energy for regeneration, and is thus advantageous for CO₂ capture.

The reaction between a 3DMA1P aqueous solution activated by piperazine and CO₂ can be explained by a homogeneous activation mechanism or a shuttle mechanism. The following reactions may take place in CO₂ absorption by a 3DMA1P+PZ aqueous solution.

CO₂+H₂O H₃O⁺+HCO₃⁻ (1)

HCO₃⁻+H₂O H⁺+CO₃²⁻ (2)

PZ+H₃O⁺PZH⁺+H₂O (3)

PZ+CO₂PZ-CO₂ (4)

PZ-CO₂+3DMA1P PZ+3DMA1P-CO₂ (5)

PZ-CO₂+H₂O PZCOO⁻+H₃O⁺ (6)

PZCOO⁻+3DMA1P+H₂O3DMA1PH⁺+HCO₃⁻+PZ (7)

PZCOO⁻+CO₂+H₂O PZ(COO⁻)₂+H₃O⁺ (8)

3DMA1P+H₃O⁺3DMA1PH⁺+H₂O (9)

CO₂+3DMA1P3DMA1P-CO₂ (10)

3DMA1P-CO₂+H₂O3DMA1PH⁺+HCO₃⁻ (11)

The dissociation of CO₂ to form bicarbonate and carbonate ions occurs by reactions shown in Formulas (1) and (2). PZ is protonated to form protonated PZ (Formula (3)). CO₂ absorbed by free PZ (Formula (4)) can be transferred to 3DMA1P as shown in Formula (5), and at the same time, reacts with water to form a carbamate (Formula (6)), and this carbamate reacts with 3DMA1P to form a bicarbonate (Formula (7)). PZ has two amine groups and can theoretically react with 2 moles of CO₂, but the reaction in which the second amine group binds to the second CO₂ (Formula (8)) can be neglected. Effective free PZ, although at a remarkably low concentration, is a homogeneous activator that can transfer CO₂ to 3DMA1P and accelerate the CO₂ absorption rate.

The amine mixture may contain the first amine compound and the second amine compound at a weight ratio of 2 to 15:1. For example, there is a problem in increasing the amount of CO₂ absorbed by the absorbent when the weight ratio is less than 2:1, and when the weight ratio exceeds 15:1, the amount of CO₂ absorbed by the absorbent can be increased but there may be a problem in that the absorption rate decreases.

The content of the amine mixture may be 30% to 50% by weight, preferably 35% to 45% by weight based on 100% by weight of the total amount of the carbon dioxide capture agent. When the content is less than 30% by weight, the amine content is low, so the amount of carbon dioxide absorbed by the amine-containing absorbent is small, and there may be a problem with the cyclic absorbed amount (rich amine-lean amine, amount of CO₂ absorbed in absorption tower-CO₂ content in absorbent after CO₂ stripping in the stripping tower), which indicates the performance of the subsequent capture process. When the content exceeds 50% by weight, the viscosity of the absorbent is high, this may cause problems in mass transfer and heat transfer during continuous CO₂ absorption and absorbent regeneration, and there may be a problem in the operation of continuous capture process. For example, the first amine compound may be contained at 40% by weight or less, 37.5% by weight or less, 35% by weight or less, 32.5% by weight or less, 31% by weight or less, 30% by weight or less, or 29% by weight or more, and the second amine compound may be contained at 10% by weight or more, 9% by weight or more, 7.5% by weight or more, 5% by weight or more, 2.5% by weight or more, or 1% by weight or more.

A second aspect of the present disclosure provides a carbon dioxide capture method including a step S1 of preparing a liquid absorbent containing an amine mixture; a step S2 of bringing the liquid absorbent into contact with a gas containing carbon dioxide; a step S3 of absorbing carbon dioxide from the gas; and a step S4 of desorbing the carbon dioxide.

Detailed description of parts overlapping with the first aspect of the present disclosure has been omitted, but the contents described in the first aspect of the present disclosure can be applied equally even if the description is omitted in the second aspect.

In an exemplary embodiment of the present disclosure, the S1 may be a step of preparing a liquid absorbent.

The liquid absorbent may contain an amine mixture, and the amine mixture may contain a first amine compound and a second amine compound.

The first amine compound and second amine compound are as described above, and preferably the first amine compound may be 3-dimethylamino-1-propanol (3DMA1P) and the second amine compound may be piperazine (PZ).

The liquid absorbent may contain the amine mixture at a weight ratio of 2 to 15:1. There is a problem in increasing the amount of CO₂ absorbed by the absorbent when the weight ratio is less than 2:1, and when the weight ratio exceeds 15:1, the amount of CO₂ absorbed by the absorbent can be increased but there may be a problem in that the absorption rate decreases.

The amine mixture may be contained at 35% to 45% by weight based on 100% by weight of the total amount of the liquid absorbent. When the content is less than 30% by weight, the amine content is low, so the amount of carbon dioxide absorbed by the amine-containing absorbent is small, and there is a problem with the cyclic absorbed amount (rich amine-lean amine, amount of CO₂ absorbed in absorption tower-CO₂ content in absorbent after CO₂ stripping in the stripping tower), which indicates the performance of the subsequent capture process. When the content exceeds 50% by weight, the viscosity of the absorbent is high, this may cause problems in mass transfer and heat transfer during continuous CO₂ absorption and absorbent regeneration, and there may be a problem in the operation of continuous capture process.

The liquid absorbent may further contain an accelerator, and the accelerator may include, for example, one or more selected from the group consisting of propylamine, dipropylamine, butylamine, dibutylamine, isobutylamine, 1,2-dimethyl propylamine, hexylamine, N, N-dimethyl allylamine, dimethylamino ethylamine, 1,3-diamino propane, methylamino propylamine, N-aminoethyl morpholine, iminobispropylamine, 2-pipecoline, 2,4-lupetidine, N-amino-4-pipecoline, 2-piperidine ethanol, 4-piperidinol, N-methyl benzylamine, dibenzylamine, phenethylamine, pyrazine, 2-methyl pyrazine, 2-methyl piperazine, 2,3-lutidine, 2-methyl-4-ethyl pyridine, 4-alkyl pyridine, picolinic acid, 2-aminonicotinic acid, 3-amino pyridine, 3-decyloxy propylamine, and any combination thereof.

In an exemplary embodiment of the present disclosure, the S2 may be a step of bringing into contact with gas.

The gas may contain carbon dioxide.

In an exemplary embodiment of the present disclosure, the S3 may be a step of absorbing carbon dioxide.

The S3 may be performed at a temperature of 300 to 330 K. When the temperature is less than 300 K, there may be a problem of consuming a large quantity of energy to cool the exhaust gas in the pretreatment step because the temperature is lower than that of the exhaust gas discharged during combustion. When the temperature exceeds 330 K, the temperature of the absorbent is high, so there may be a problem that the amount of CO₂ absorbed by the absorbent is small because of the high temperature when CO₂ comes into contact with the absorbent in the absorption tower.

The S3 may be performed at a pressure of 1 to 10 kPa. When the pressure exceeds 10 kPa, the pressure is higher than that of the exhaust gas discharged during combustion, so there may be a problem of consuming a large quantity of energy to increase the pressure of the exhaust gas in the pretreatment step.

In an exemplary embodiment of the present disclosure, the S4 may be a step of desorbing carbon dioxide.

The S4 may be performed at a temperature of 380 to 410 K. When the temperature dis less than 300 K, there may be a problem of consuming a large quantity of energy to cool the exhaust gas in the pretreatment step because the temperature is lower than that of the exhaust gas discharged during combustion. When the temperature exceeds 330 K, the temperature of the absorbent is high, so there may be a problem that the amount of CO₂ absorbed by the absorbent is small because of the high temperature when CO₂ comes into contact with the absorbent in the absorption tower.

The S4 may be performed at a pressure of 90 to 100 kPa. When the pressure is less than 90 kPa, the pressure is lower than that of the exhaust gas, so the partial pressure of CO₂ in the exhaust gas is low, and there may be a problem that the amount of CO₂ absorbed in the absorption tower is small. When the pressure exceeds 100 kPa, the exhaust gas is required to be compressed, so there may be a problem of consuming a large quantity of energy to increase the pressure of the exhaust gas.

As the content of the second amine compound in the liquid absorbent increases, the CO₂ loading may increase.

As the content of the second amine compound in the liquid absorbent increases, the CO₂ absorption rate may increase.

As the content of the second amine compound in the liquid absorbent increases, the heat of absorption (ΔH; KJ/mol of CO₂) may increase.

Hereinafter, Examples of the present invention will be described in detail so that those skilled in the art to which the present invention pertains can easily practice the present invention. However, the present invention may be implemented in various different forms, and is not limited to Examples described herein.

### Example 1

An amine mixture containing 3DMA1P and PZ at a weight ratio of 3:1 was added, then water was mixed to prepare an amine absorbent, the total amount of the amine absorbent was adjusted to 100 gr (103.5 ml), and stirring was performed for 60 minutes, thereby preparing a 0.407 M aqueous solution of carbon dioxide capture agent.

(hereinafter referred to as 3DMA1P 30+PZ 10)

### Example 2

An amine mixture containing 3DMA1P and PZ at a weight ratio of 4.3:1 was added, then water was mixed to prepare an amine absorbent, the total amount of the amine absorbent was adjusted to 100 gr (104.1 ml), and stirring was performed for 60 minutes, thereby preparing a 0.402 M aqueous solution of carbon dioxide capture agent.

(hereinafter referred to as 3DMA1P 32.5+PZ 7.5)

### Example 3

An amine mixture containing 3DMAP and PZ at a weight ratio of 7:1 was added, then water was mixed to prepare an amine absorbent, the total amount of the amine absorbent was adjusted to 100 gr (104.7 ml), and stirring was performed for 60 minutes, thereby preparing a 0.397 M aqueous solution of carbon dioxide capture agent.

(hereinafter referred to as 3DMA1P 35+PZ 5)

### Example 4

An amine mixture containing 3DMA1P and PZ at a weight ratio of 15:1 was added, then water was mixed to prepare an amine absorbent, the total amount of the amine absorbent was adjusted to 100 gr (105.3 ml), and stirring was performed for 60 minutes, thereby preparing a 0.393 M aqueous solution of carbon dioxide capture agent.

(hereinafter referred to as 3DMA1P 37.5+PZ 2.5)

### Comparative Example 1

An aqueous solution of carbon dioxide capture agent was prepared in the same manner as in Example 1 except that MEA was contained at 30% by weight instead of an amine mixture.

(hereinafter referred to as MEA 30)

### Comparative Example 2

An aqueous solution of carbon dioxide capture agent was prepared in the same manner as in Example 1 except that 3DMA1P was contained at 40% by weight instead of an amine mixture.

(hereinafter referred to as 3DMA1P 40)

### Experimental Example 1: Measurement of Equilibrium CO₂ Solubility

FIG. 2 illustrates a gas-liquid equilibrium experimental apparatus used for the CO₂ equilibrium solubility experiment and absorption rate measurement. 99.99 vol % CO₂ was used as the gas fed to the gas-liquid equilibrium apparatus, and the gas was injected into the reactor after being preheated in the reservoir. The experimental temperature was maintained using an oven, and the experiment was conducted at 313 K and 393 K, which were the temperatures in general absorption and stripping towers, respectively. The volume of the reactor was 200 mL, and the capture agent used was 110 g. The stirring speed was maintained at 300 RPM, and the contact area between the capture agent and gas was increased. Gas preheated in the reservoir is injected into the reactor, and the operation is repeated when the pressure in the reactor reached equilibrium. As a result, the experiment was terminated when the pressure of the gas in the reactor was the same as the pressure of the gas in the reservoir and the gas was not injected any more, and the CO₂ loading value was calculated by applying the equations below.

Since the experimental conditions were carbon dioxide in combustion exhaust gas discharged at normal pressure, the absorbed amount was calculated using the ideal gas equation, assuming that the compression factor of CO₂ was 1.

The equilibrium partial pressure (P*_{CO}_{₂}) of carbon dioxide in the reactor can be expressed as the value obtained by subtracting the initial pressure (P^{O}) from the equilibrium pressure (P*) after absorption equilibrium is achieved as shown in Equation (1-1).

$${P}_{{CO}_{2}}^{*} = ( {P}^{*} - P ° ) \qquad ( 1 - 1 )$$

The number of moles of injected carbon dioxide is determined by subtracting the pressure (P_{ST}) after carbon dioxide injection into the reactor from the initial pressure (P_{Si}) of the feeder to obtain a value, multiplying the value by the volume (V_{S}) of the feeder to obtain a value, dividing the value by RT, and applying the ideal gas equation as shown in Equation (1-2).

The number of moles of carbon dioxide in the gas phase of the reactor when equilibrium is reached is determined by subtracting the initial pressure (P_{Ri}) Of the reactor in a vacuum state from the final pressure (P_{RT}) of the reactor to obtain a value, multiplying the value by the gas phase volume (V_{R}) of the reactor to obtain a value, dividing the value by RT, and applying the ideal gas equation as shown in Equation (1-3). Finally, the number of moles of carbon dioxide absorbed is determined as the difference between the two values as shown in Equation (1-4).

$$Feeder ( gas reserv oir ) : {n}_{{S}_{{CO}_{2}}} = \frac{( {P}_{Si} - {P}_{St} ) \cdot {V}_{S}}{{RT}_{S}} \qquad ( 1 - 2 )$$

$$Reactor : {n}_{{R}_{{CO}_{2}}} = \frac{( {P}_{Rt} - {P}_{Ri} ) \cdot {V}_{R}}{{RT}_{R}} \qquad ( 1 - 3 )$$

$$Number of moles of {CO}_{2} absorbed : {n}_{{absorbed}_{{CO}_{2}}} = {n}_{{S}_{{CO}_{2}}} - {n}_{{R}_{{CO}_{2}}} \qquad ( 1 - 4 )$$

CO₂ loading can be expressed as the absorption capacity that is the value obtained by dividing the number of moles

$$( {n}_{{absorbed}_{{co}_{2}}} )$$

of carbon dioxide absorbed by the capture agent by the number of moles (nₐₘᵢₙₑ) of amine, and is shown in Equation (1-5).

$${CO}_{2} loading = \frac{{n}_{{absorbed}_{{CO}_{2}}}}{{n}_{amine}} \qquad ( 1 - 5 )$$

CO₂ solubility at equilibrium is an important parameter that indicates the CO₂ capture performance of the capture agent and the maximum amount of CO₂ that can be absorbed by a liquid solution at specific temperature and CO₂ partial pressure. In this experiment, the CO₂ equilibrium solubility value of 30 wt % aqueous solution of MEA depending on the partial pressure was first measured at a temperature of 313 K, and the obtained data was compared with literature data in order to demonstrate the feasibility of the apparatus. The results are consistent with the literature data, as illustrated in FIG. 3.

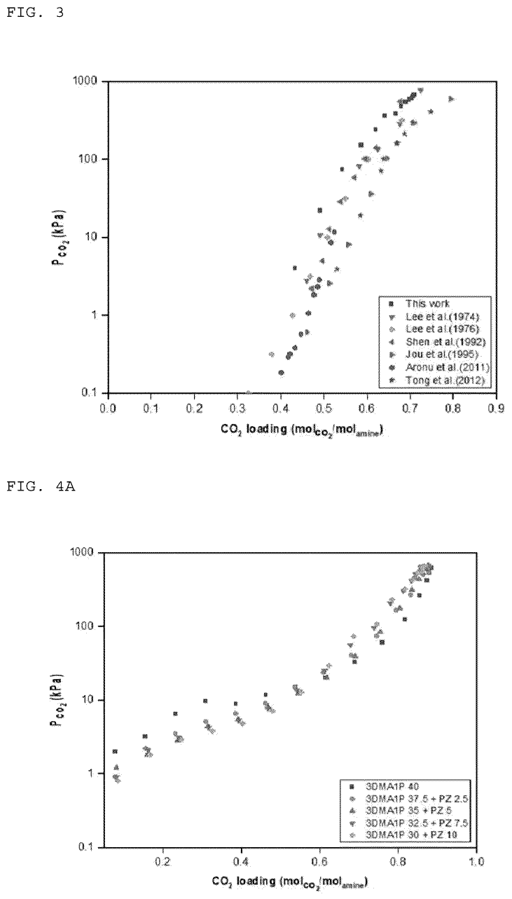

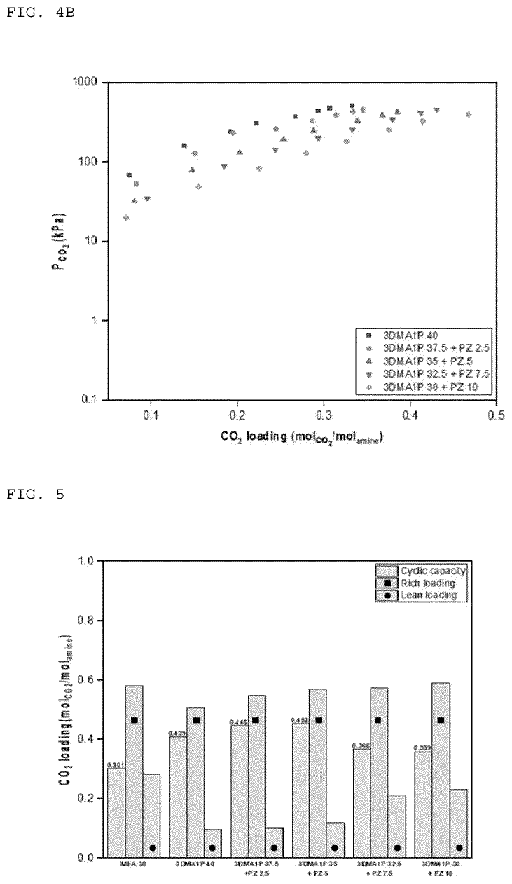

After the reliability of the experimental apparatus was demonstrated under identical operating conditions, the equilibrium CO₂ solubility in the absorption by the 3DMA1P single capture agent and 3DMA1P+PZ mixed capture agent was measured at temperatures of 313 K and 393 K and various CO₂ partial pressures. FIGS. 4A and 4B illustrate the equilibrium CO₂ solubility in capture agents containing amine mixtures at 313 K and 393 K, respectively, and Table 1 summarizes the experimental results.

Referring to FIG. 3, the equilibrium CO₂ solubility in all capture agents increases as the CO₂ partial pressure increases. Referring to FIG. 4A, the equilibrium CO₂ solubility tends to increase as the PZ content increases at the same pressure at low pressures, but when complete equilibrium is achieved, the CO₂ loading (mol_{CO}_{₂}/molₐₘᵢₙₑ) value decreases to 0.885 in the case of 3DMA1P 40 capture agent and to about 0.866 in the case of a 3DMA1P 30+PZ 10 capture agent. This is associated with the CO₂ loading values and molecular weights of single amines. The theoretical CO₂ loading (mol_{CO}_{₂}/molₐₘᵢₙₑ) values of 3DMA1P and PZ are each 1, but according to literatures, the CO₂ loading value of 3DMA1P is about 0.89 and the CO₂ loading value of PZ is about 1.1, with PZ having a greater CO₂ loading value. However, the molecular weight of 3DMA1P is 103.16 g/mol and that of PZ is 86.136 g/mol, so the overall number of moles of amines tends to increase as the ratio of PZ in the capture agent increases, and accordingly, the CO₂ loading (mol_{CO}_{₂}/molₐₘᵢₙₑ) value tends to decrease. In order to support this assertion, the unit was converted to the CO₂ loading (mol_{CO}_{₂}/kgₛₒₗᵥₑₙₜ) value and the results are shown in Table 1. The total amount of CO₂ absorbed increased as the ratio of PZ increased.

FIG. 4B illustrates the equilibrium CO₂ solubility at a high temperature of 393 K. The opposite result was obtained in that the CO₂ loading (mol_{CO}_{₂}/molₐₘᵢₙₑ) value increased as the ratio of PZ increased. This can be explained by the vapor pressure measurement results shown in Table 2 of Experimental Example 7 below, and it can be inferred that this indicates a decrease in CO₂ loading value due to the loss of the capture agent since the volatility increases as the PZ ratio decreases.

TABLE 1

CO₂ loading amount

| | Temperature | mol_{co} [symbol] / | mol_{co} [symbol] / |
|---|---|---|---|
| Absorbents | (K) | molₐₘᵢₙₑ | molₐₘᵢₙₑ |
| MEA 30 | 313 | 0.581 | 2.905 |
| 3DMA1P 40 | | 0.885 | 3.43 |
| 3DMA1P 37.5 + PZ 2.5 | | 0.88 | 3.455 |
| 3DMA1P 35 + PZ 5 | | 0.876 | 3.464 |
| 3DMA1P 32.5 + PZ 7.5 | | 0.862 | 3.465 |
| 3DMA1P 30 + PZ 10 | | 0.866 | 3.523 |
| MEA 30 | 393 | 0.447 | 2.195 |
| 3DMA1P 40 | | 0.333 | 1.292 |
| 3DMA1P 37.5 + PZ 2.5 | | 0.345 | 1.356 |
| 3DMA1P 35 + PZ 5 | | 0.385 | 1.528 |
| 3DMA1P 32.5 + PZ 7.5 | | 0.431 | 1.733 |
| 3DMA1P 30 + PZ 10 | | 0.467 | 1.901 |

[symbol]

indicates data missing or illegible when filed

### Experimental Example 2: Measurement of Cyclic Capacity

Cyclic capacity is an important parameter that determines the height of the absorption tower in the CO₂ capture process. The loading value when the capture agent absorbed CO₂ at 313 K was called rich CO₂ loading and the loading value when the capture agent was regenerated at 393 K was called lean CO₂ loading, and the difference therebetween was called the cyclic capacity. Cyclic capacity was used to examine the absorption and regeneration performance of a capture agent. Cyclic capacity is expressed by Equation (2-1).

$$Cyclic capacity = Rich loading ( {mol}_{{CO}_{2}} / {mol}_{amine} ) - Lean loading ( {mol}_{{CO}_{2}} / {mol}_{amine} ) \qquad ( 2 - 1 )$$

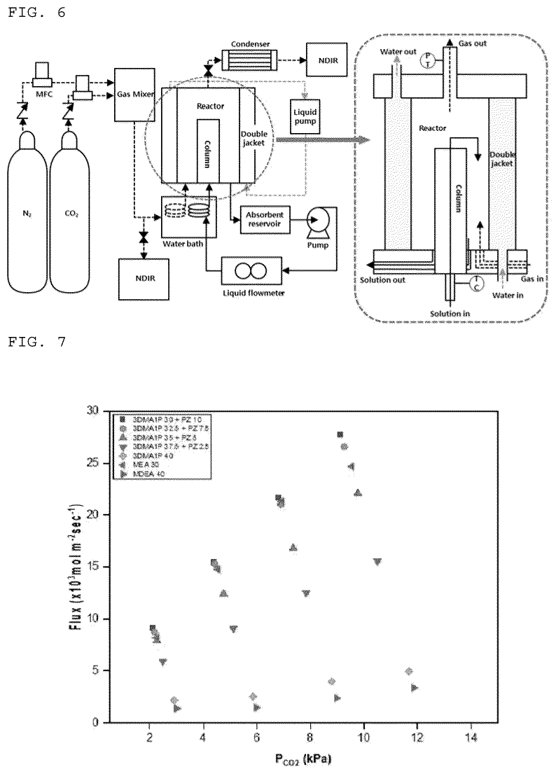

Loading values at the respective temperatures and partial pressures were determined using the origin plot. FIG. 5 illustrates the calculated cyclic capacity values for comparison. The cyclic capacity of commercially available MEA 30 was calculated to be 0.301 mol_{CO}_{₂}/molₐₘᵢₙₑ 3DMA1P 40, 3DMA1P 37.5+PZ 2.5, 3DMA1P 35+PZ 5, 3DMA1P 32.5+PZ 7.5, and 3DMA1P 30+PZ 10 had a cyclic capacity higher than that of MEA 30 by 36%, 48%, 50%, 22%, and 20%, respectively. The cyclic capacity tended to increase and then decrease as the PZ content increased, but the cyclic capacity of all capture agents was higher than that of MEA 30, so it has been found that the size of the absorption tower in the process can be reduced and the reboiler heat duty diminishes by lower sensible heat.

### Experimental Example 3: Measurement of Overall Mass Transfer Coefficient

The overall mass transfer coefficient of capture agents was measured using a wetted wall column (WWC) apparatus. The configuration of the WWC apparatus is illustrated in FIG. 6. WWC consists of a stainless steel tube having a height of 90 mm and an outer diameter of 12.6 mm. The column is surrounded by glass, two other glass walls create a double jacket, and water circulates through the double jacket to transfer heat. At this time, the temperature was maintained constant at 313 K using a thermostat. The liquid capture agent flows at a flow rate of 150 mL/min, and the fed gas flows from the bottom at a flow rate of 5 L/min, the capture agent and gas come into contact and react with each other, then the gas is discharged to the top and the capture agent is discharged to the bottom. The experiment was conducted by changing the concentration of injected CO₂ from 3 vol % to 9 vol %. The gas concentration was continuously analyzed using a non-dispersive infrared gas detector (NDIR). The CO₂ concentrations at the inlet and outlet obtained using NDIR also provide information on the CO₂ partial pressure.

The overall mass transfer coefficient (K_{G}) was calculated in the following order. The amount (P_{CO}_{₂}−P*_{CO}_{₂}) of CO₂ absorbed at the gas-liquid interface and the mass flux (N_{CO}_{₂}) were calculated by multiplying the driving force by K_{G}. Since it is difficult to obtain the concentration of CO₂ at the interface, K_{G} and the equilibrium partial pressure (P_{CO}_{₂}) of CO₂ were used.

$${N}_{{CO}_{2}} = {K}_{G} ( {P}_{{CO}_{2}} {P}_{{CO}_{2}}^{*} ) \qquad ( 3 - 1 )$$

The pressure difference, namely, driving force, can be expressed using the logarithmic mean pressure difference.

$$Δ {P}_{{CO}_{2} , l m} = \frac{{P}_{{CO}_{2 , in}} - {P}_{{CO}_{2} , out}}{ln ( ( {P}_{{CO}_{2} , in} - {P}_{{CO}_{2}}^{*} ) / ( {P}_{{CO}_{2} , out} - {P}_{{CO}_{2}}^{*} ) )} \qquad ( 3 - 2 )$$

The P_{CO}_{₂}ᵢₙ and P_{CO}_{₂}ₒᵤₜ values are data obtained in actual experiments, and the P*_{CO}_{₂} value is not taken into account in the case of a capture agent that is not saturated with CO₂. Accordingly, K_{G} can be expressed as follows.

$${K}_{G} = \frac{{N}_{{CO}_{2}}}{Δ {P}_{{CO}_{2} lm}} \qquad ( 3 - 3 )$$

The mass flux (N_{CO}_{₂}) can be calculated using the exposed area of the liquid film and the absorption rate (q).

$${N}_{{CO}_{2}} = \frac{q}{π {d}_{h} h} \qquad ( 3 - 4 )$$

In this equation, dₕ is the hydraulic diameter including the tube diameter (d) and liquid film thickness (f), and h is the height of the column. The hydraulic diameter (dₕ) was calculated as follows.

$${d}_{h} = d + f \qquad ( 3 - 5 )$$

The thickness (f) of liquid film can be calculated using the following equation.

$$f = {( \frac{3 μ v}{π gd ρ} )}^{\frac{1}{3}} \qquad ( 3 - 6 )$$

The viscosity and density required for the equation were measured at 313 K using a viscometer (Brookfield, DV-II+PRO) and a density meter (Anton paar, DMA 4500M). The physicochemical properties of the 3DMA1P-PZ-H₂O mixed capture agent are described in Table 2 below.

As a result, K_{G} can be determined by analyzing the linear regression of ΔP_{CO}_{₂}ᵢₘ with respect to the N_{CO}_{₂} plot for the logarithmic mean driving force of CO₂ partial pressure as shown in Equation (3-3).

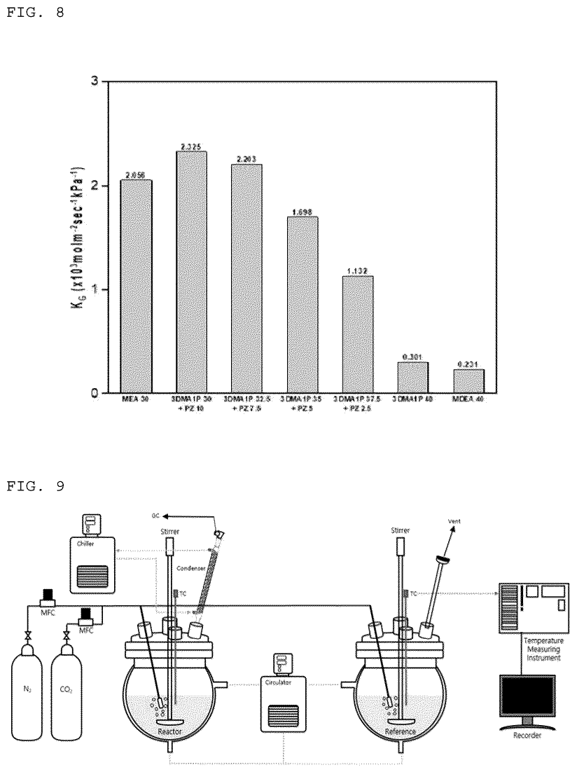

In the calculation of CO₂ loading value and cyclic capacity of a single 3DMA1P aqueous solution, relatively high results were obtained, but it is difficult to use the 3DMA1P aqueous solution alone as a capture agent since the CO₂ absorption rate thereof is slow because of the nature of tertiary amines. Accordingly, PZ was mixed to improve the absorption rate, and the mass transfer coefficient of the 3DMA1P+PZ capture agent was measured and the absorption rate was compared. The absorption rate of a capture agent is a greatly important parameter that determines the height of the tower in the CO₂ capture process, and the overall mass transfer coefficient is measured to show the result. The CO₂ absorption flux of the 3DMA1P+PZ mixed capture agent was measured at 313 K and various CO₂ concentrations (3, 6, 9, and 12 vol %) using a wetted wall column apparatus. A CO₂ unloaded capture agent was used in this experiment. The CO₂ absorption flux results of the capture agent as a function of CO₂ partial pressure are illustrated in FIG. 7. MEA 30, 3DMA1P 40 and all mixed capture agents had a higher absorption flux than MDEA 40, and the 3DMA1P 30+PZ 10 capture agent containing PZ in the most amount had the highest absorption rate.

The overall mass transfer coefficient of capture agent was obtained as the slope of the flux plot versus the logarithmic mean partial pressure change. The overall mass transfer coefficients (K_{G}) of the capture agents at 313 K are illustrated in FIG. 8 for comparison. The K_{G} of MEA 30 obtained in this experiment is 2.056×10³ mol·m⁻²·sec⁻¹·kPa⁻¹. The K_{G} of the 3DMA1P 32.5+PZ 7.5 wt % and 3DMA1P 30+PZ 10 capture agents were 2.203×10³ mol·m⁻²·sec⁻¹·kPa⁻¹ and 2.325×10³ mol·m⁻²·sec⁻¹·kPa⁻¹, respectively, and these are higher values than that of MEA 30. The 3DMA1P 30+PZ 10 capture agent had the greatest K_{G} value that is higher than MDEA 40 (0.231×10³ mol·m⁻²·sec⁻¹·kPa⁻¹) by 1000%, higher than 3DMA1P 40 (0.301×10³ mol·m⁻²·sec⁻¹·kPa⁻¹) by 770%, and higher than MEA 30 (2.056×10³ mol·m⁻²·sec⁻¹·kPa⁻¹) by about 13%.

It can be seen that single 3DMA1P has a higher K_{G} value than MDEA, and this can be explained by the difference in molecular structure as mentioned above. The 3DMA1P 37.5+PZ 2.5 capture agent has the lowest K_{G} among the mixed capture agents, but it is a result improved by about 400% when compared to that of the 3DMA1P 40 capture agent. This is a result verifying that PZ acts as an activator in the mechanism proposed in the present invention. The activator is a CO₂ carrier and enhances the mass transfer of CO₂ at the interface. When an amine that is highly reactive and has a small molecular size, such as PZ, is used as an activator, the amine is effective as a CO₂ transfer medium since the amine can easily move between the liquid film and the liquid bulk. As a result, PZ used as an activator in the present invention can greatly improve the CO₂ absorption rate of a 3DMA1P aqueous solution.

### Experimental Example 4: Measurement of Heat of Absorption

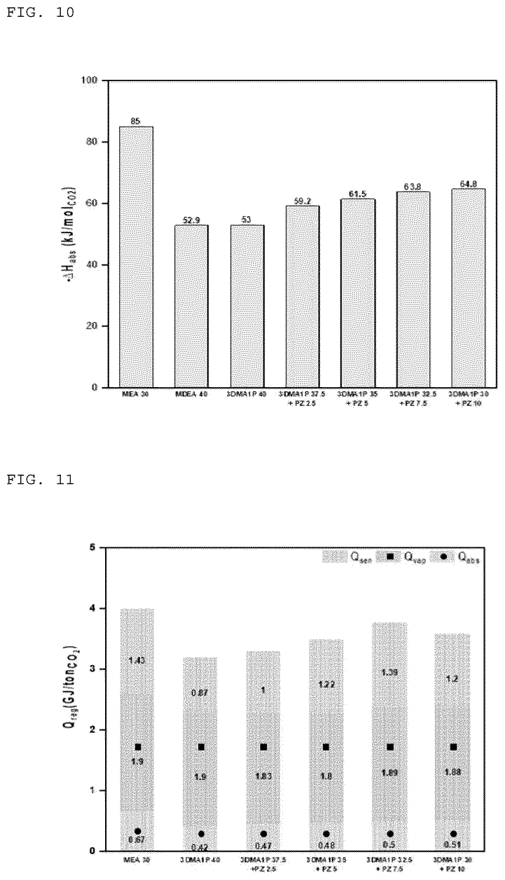

Differential reaction calorimeter (DRC, Setaram) is an apparatus that measures the quantity of heat generated when an amine capture agent reacts with CO₂. FIG. 9 illustrates the configuration of a DRC apparatus. 200 g of capture agent was injected into the measurement reactor and reference reactor each having a volume of 250 mL, and water was circulated through a circulator between the reactors and the glass jacket to maintain the reaction temperature at 313 K. The two reactors were connected by one digital stirrer and stirred at 200 RPM to increase the contact area between the capture agent and the gas. The temperature of each capture agent was recorded in real time using a thermocouple. A probe for compensation for Joule effect was installed in the measurement reactor. N₂ gas was injected into the reference reactor at a flow rate of 200 mL/min, and CO₂ 15 vol % (N₂ balance) was injected into the measurement reactor at a flow rate of 200 mL/min using MFC. The injected gas was fed in the form of bubbles using a bubble injector. The gas passed through the capture agent was allowed to pass through a gas chromatograph (GC, Agilent 7890N) at a flow rate of 56 mL/min to measure the CO₂ concentration and to calculate the amount of CO₂ dissolved in the capture agent. When the temperature difference (T) between the two reactors reached a constant value, the reaction was considered to be completed and the experiment was terminated.

To measure the heat of reaction using DRC, the amount of CO₂ dissolved in the capture agent is to be first calculated. The number of moles of CO₂ at the beginning of injection and the number of moles of CO₂ discharged after reaction can be calculated by applying the ideal gas equation in Equations (4-1) and (4-2). Finally, the difference between the two moles is used to calculate the amount of CO₂ dissolved in the capture agent through Equation (4-3).

$${n}_{{CO}_{2} , in} = \frac{{P}_{{CO}_{2} , in} \cdot {V}_{{CO}_{2} , in}}{R \cdot {T}_{{CO}_{2} , in}} \qquad ( 4 - 1 )$$

$${n}_{{CO}_{2} , out} = \frac{{P}_{{CO}_{2} , out} \cdot {V}_{{CO}_{2} , out}}{R \cdot {T}_{{CO}_{2} , out}} \qquad ( 4 - 2 )$$

$${n}_{{absorbedCO}_{2}} = {n}_{{CO}_{2} , in} - {n}_{{CO}_{2} , out} \qquad ( 4 - 3 )$$

The total amount of CO₂ dissolved in the capture agent can be calculated through integration over time with the number of moles of CO₂ calculated from the equation.

Electrical correction was performed to determine the reactor heat transfer coefficient (UA) (W/° C.) before and after the reaction between the capture agent and CO₂ prior to measurement of the heat of reaction. The UA value can be determined through electrical correction by the Joule effect. Electrical energy injected into the reactor is consumed through the walls of the reactor, and a temperature change curve is generated. At this time, the UA value can be determined through Equation (4-4) by integrating the area of the temperature change curve over time.

$${Q}_{flow} = UA \cdot {\int }_{0}^{t} Δ T dt \qquad ( 4 - 4 )$$

UA has different values depending on the change in chemical composition and mixing of samples. Therefore, it is required to determine the average of UA values obtained by performing corrections 2 to 3 times before CO₂ is injected into the capture agent and after the reaction is completed.

$${UA}_{average} = \frac{1}{2} ( {UA}_{1} + {UA}_{2} ) \qquad ( 4 - 5 )$$

UA₁ and UA₂ are the heat transfer values before and after the reaction. The calculated UA_{average} was multiplied by the area value of the temperature change curve over time recorded during the CO₂ absorption reaction of the capture agent to derive the value of heat of reaction (Qᵣ). The calculation formula for heat of reaction is as follows.

$${Q}_{r} = {UA}_{average} \cdot {\int }_{0}^{t} Δ T dt \qquad ( 4 - 6 )$$

The values of heat of absorption of the capture agents measured at a temperature of 313 K using DRC were compared with one another, and the results are as illustrated in FIG. 10. According to the results reported by Hadri et al. [EL HADRI, Nabil, et al. Aqueous amine solution characterization for post-combustion CO₂ capture process. Applied Energy, 2017, 185:1433-1449.], the heat of absorption of 30 wt % aqueous solution of MEA was 85.13 kJ/mol_{CO2}, demonstrating the validity of the values measured in the present invention, so the results obtained using the apparatus and method used in this experiment can be reliable. The highest value of heat of absorption is 85 kJ/mol_{CO2} (MEA 30), and the lowest value is 52.9 kJ/mol_{CO2} (MDEA 40). 3DMA1P 40 has a value close to that of MDEA 40. In the case of a mixed capture agent of 3DMA1P and PZ, the heat of absorption tends to increase in the range of 59.2 to 64.8 kJ/mol_{CO2} as the ratio of PZ increases. This indicates that the heat of absorption of mixed capture agents increases as the ratio of PZ, which has two primary amino groups that generate stable carbamate ions when reacting with CO₂, increases.

On the other hand, tertiary amines MDEA and 3DMA1P generate bicarbonate and carbonate ions, and the heat of absorption thereof is relatively low. In the case of 3DMA1P 30+PZ 10, which has the highest heat of absorption among mixed capture agents, the heat of absorption is 64.8 kJ/mol_{CO2}, which is a value decreased by about 25% compared to that of MEA 30. As a result, it can be considered that all capture agents containing amine mixtures are more effective in regeneration compared to MEA 30.

### Experimental Example 5: Energy Consumption in CO₂ Capture Process

Energy consumption in the CO₂ capture process is generally called reboiler heat duty since the total energy for regeneration of capture agent is supplied by the hot steam passing through the reboiler present in the stripping tower. Reboiler heat duty can be described as the sum of the following three terms and was calculated using the equation presented by Oexmann et al. [OEXMANN, Jochen; KATHER, Alfons. Minimising the regeneration heat duty of post-combustion CO₂ capture by wet chemical absorption: The misguided focus on low heat of absorption solvents. International Journal of Greenhouse Gas Control, 2010, 4.1:36-43.].

$${q}_{reb} = {q}_{sens} + {q}_{vap , {H}_{2} O} + {q}_{abs , {CO}_{2}} \qquad ( 5 - 1 )$$

In this equation, qₛₑₙₛ is the sensible heat required to heat the capture agent to the regeneration temperature, q_{vap,H}_{₂}_{O} represents the heat of vaporization, which directly indicates the quantity of water vapor required in the reboiler for CO₂ desorption, q_{abs,CO}_{₂} is the heat of absorption generated when the capture agent reacts with CO₂, and the same quantity of heat as that of heat released from the exothermic reaction in the absorption tower is required to be supplied into the stripping tower to reverse the absorption process and desorb CO₂. As a result, reboiler heat duty is required to be provided for regeneration of CO₂-loaded capture agent in the CO₂ capture process. The equation presented by Oexmann et al. is as follows.

$${}_{\approx } {q}_{reb} \approx [ \frac{{C}_{p} ( {T}_{reb} - {T}_{feed} )}{Δ α} \cdot \frac{{M}_{sol}}{{M}_{{CO}_{2}}} \cdot \frac{1}{{x}_{sol}} ] + [ \text{} Δ {H}_{vap , {H}_{2} O} \cdot \frac{{P}_{{H}_{2} O}}{{P}_{{CO}_{2}}} \cdot \frac{1}{{M}_{{CO}_{2}}} ] + [ \frac{Δ {H}_{abs , {CO}_{2}}}{{M}_{{CO}_{2}}} ] \qquad ( 5 - 2 )$$

(Reboiler Heat=Sensible Heat+Heat of Vaporization+Heat of Absorption)

The factors included in the equation can be defined as the specific heat capacity (Cₚ), cyclic capacity (α), temperatures (T_{reb}, T_{read}) of the reboiler and absorption tower, molar masses (Mₛₒₗ, M_{CO}_{₂}) of capture agent and CO₂, mole fraction (xₛₒₗ) of amine in the solution, heat of evaporation (ΔH_{vap,H}_{₂}_{O}), partial pressures (P_{H}_{₂}_{O}, P_{CO}_{₂}) of water vapor and CO₂ under CO₂ desorption conditions, and heat of reaction (ΔH_{abs,CO}_{₂}) between capture agent and CO₂. Some of these factors are not independent, so a holistic approach is needed that considers all contributing factors simultaneously.

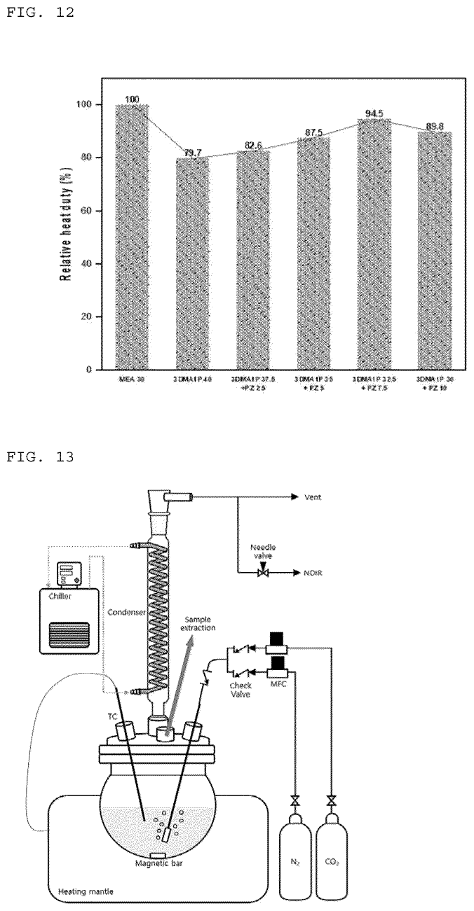

Reboiler heat duty was calculated using Equation (5-2) presented by Oexmann et al. FIG. 11 illustrates the values of sensible heat, latent heat, and heat of absorption of each capture agent and the total sum thereof. As the content of PZ increased, sensible heat and heat of reaction tended to increase.

Among these, 3DMA1P 32.5+PZ 7.5 had relatively high specific heat (Table 2) and low cyclic capacity and thus had the highest sensible heat value.

3DMA1P 30+PZ 10, which had the highest PZ content, had the greatest heat of reaction since a larger number of reaction for carbamate production takes places as the content of PZ increases.

The correlation of latent heat with the content of PZ was not found, and the latent heat of all capture agents was similar to that of MEA 30. The Q_{reg} of MEA 30 was found to be about 4.0 GJ/ton_{CO}_{₂}, the Q_{reg} of 3DMA1P 40, 3DMA1P 37.5+PZ 2.5, 3DMA1P 35+PZ 5, and 3DMA1P 37.5+PZ 2.5 were 3.19, 3.30, 3.50, 3.78, and 3.59 GJ/ton_{CO}_{₂}, respectively, and all capture agents had decreased values compared to MEA 30. FIG. 12 illustrates the relative heat duty when the Q_{reg} value of MEA 30 is regarded as 100. 3DMA1P 40, 3DMA1P 37.5+PZ 2.5, 3DMA1P 35+PZ 5, and 3DMA1P 37.5+PZ 2.5 had heat duty decreased by 20.3%, 17.4%, 12.5%, 5.5%, and 10.2% compared to MEA 30. 3DMA1P 32.5+PZ 7.5 has higher heat duty than 3DMA1P 30+PZ 10, which has the highest PZ content, and this can be explained by the difference in the measured specific heat values in Table 2.

As a result, all capture agents, which contain amine mixtures and have been tested in this study, have lower reboiler heat duty than MEA 30 and require a smaller quantity of energy for regeneration than MEA 30 in the CO₂ capture process, and thus can be considered to have economic advantages and potential in CO₂ capture.

### Experimental Example 6: ¹³C Nuclear Magnetic Resonance Spectroscopy

The species distribution of 3DMA1P+PZ aqueous solution was determined using a BRUCKER AVANCE 400 MHZ NMR spectrometer. 13C NMR measurement was performed at 293 K on CO₂-loaded mixed capture agent. The spectrum was obtained by ¹³C NMR with a delay time of 2 minutes, and the number of scans (NS) was 64 to obtain accurate peaks. The CO-containing mixed capture agent was prepared using a batch reactor. FIG. 13 illustrates a batch reactor used for sampling.

Through ¹³C NMR analysis, the species of products produced when the mixed amine aqueous solution absorbed carbon dioxide were identified and quantitatively evaluated. The products that can be evaluated in the 3DMA1P-PZ-H—O—CO₂ system through ¹³C NMR spectrum are PZ, protonated PZ (PZH⁺), PZ carbamate (PZCOO⁻), PZ dicarbamate (PZ(COO⁻)₂), 3DMA1P, protonated 3DMA1P (3DMA1PH⁺), bicarbonate (HCO³⁻), and carbonate (CO₃²⁻).

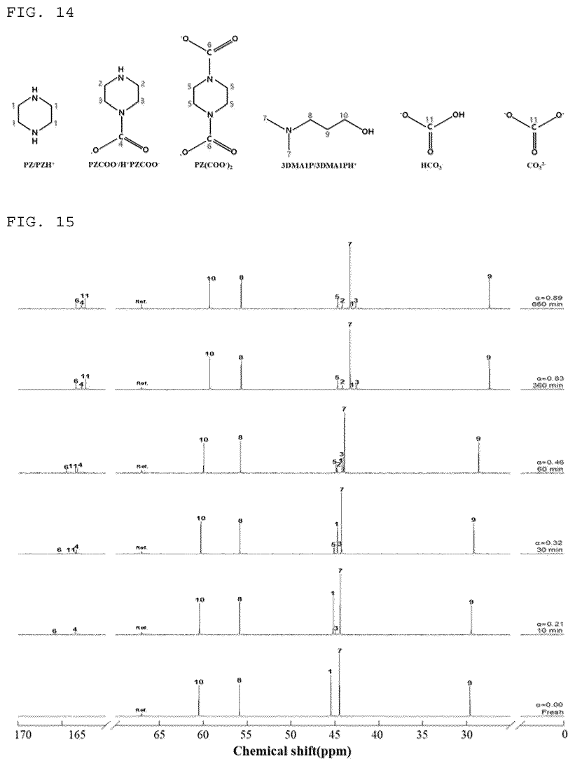

As illustrated in FIG. 14, each corresponding carbon was assigned a number to indicate the chemical species of the corresponding peaks in the ¹³C NMR spectrum.

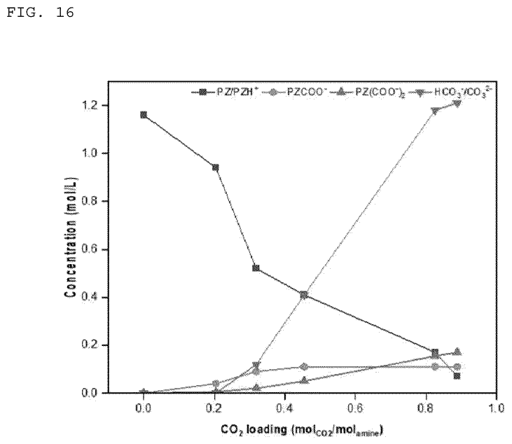

The peaks of each species in the stacked 13C NMR spectrum for the 3DMA1P-PZ-H₂O—CO₂ system are illustrated in FIG. 15. The peak appearing at δ=67.00 ppm is 1,4-dioxane used as a reference material. The chemical shifts of the 3DMA1P peak before CO₂ injection appeared at δ=44.49, 55.87, 29.62, and 60.5 ppm, respectively, in the order of numbers 7, 8, 9, and 10 assigned in FIG. 14, and the chemical shift appeared at δ=45.46 ppm in the case of PZ. After 10 minutes of reaction with CO₂, chemical shifts appeared in the peaks of carbamate (signal 4) and dicarbamate (signal 6) of PZ, which first reacted with CO₂. After 30 minutes of reaction with CO₂, the chemical shift of the carbonate/bicarbonate peak appeared at δ=163.46 ppm (signal 11), a new peak. The peaks of carbonate and bicarbonate are indistinguishable from each other because of the rapid proton exchange between the two. This can be seen as an important clue to verify the assumption that CO₂ absorbed by free PZ can be transferred to 3DMA1P, and at the same time, reacts with water to form a carbamate which reacts with 3DMA1P to form a bicarbonate in the previously presented mechanism (1-2). The production of PZ carbamate and PZ dicarbamate also gradually increased as the CO₂ loading value gradually increased, but the chemical shift of the PZ carbamate peak was not observed any more from 60 minutes after CO₂ absorption, that is at α=0.48 mol_{CO}_{₂}/molₐₘᵢₙₑ, and the chemical shift of the PZ dicarbamate peak was not observed after 360 minutes, that is at α=0.83 mol_{CO}_{₂}/molₐₘᵢₙₑ. On the other hand, the chemical shift of the carbonate/bicarbonate peak of signal 11 was observed until the reaction between the mixed capture agent and CO₂ was terminated. The changes in concentration of these three main products depending on CO₂ loading are illustrated in FIG. 16. The concentration of PZ tended to gradually decrease until the reaction was terminated, and rapidly decreased particularly to about α=0.32 mol_{CO}_{₂}/molₐₘᵢₙₑ, the initial stage of the reaction with CO₂. Afterwards, it can be seen that the increase in PZ/PZH⁺, PZ carbamate, and PZ dicarbamate decreases when the concentrations of carbonate and bicarbonate increase. As mentioned above, this is the basis for supporting the liquid phase behavior mechanism of the 3DMA1P+PZ mixed capture agent.

### Experimental Example 7: Physicochemical Properties

The physicochemical properties of solvents such as viscosity, density, pH, and vapor pressure are considered some of the important parameters used in practical process applications. Among these, viscosity and density data are essential for column design of the absorption tower and stripping tower and for determination of the reaction rate model. These data can be used to determine the column diameter, velocity, and pressure drop, and to calculate the mass transfer correlation and mass transfer area. The measurement results of physicochemical properties are shown in Table 2.

The viscosity was measured using a viscometer (Brookfield, DV-II+PRO). The measurement temperature was maintained at 313 K (±0.1) using a water circulator. The viscometer was washed using distilled water and acetone and dried, and then the next sample was injected.

The density was measured using a density meter (Anton paar, DMA 4500M), and the accuracy is 0.00001 g/cm³. The measurement temperature was controlled at 313 K (+0.1) using the temperature control function of the density meter itself. Prior to the measurement of density, distilled water was injected into the density meter for washing, and the density meter was dried and then used.

pH is an important parameter in the amine mechanism. In the reaction of aqueous amine solutions with CO₂, amines having a stronger basicity can be protonated more quickly, and this in turn is associated with CO₂ absorption ability. The pH was measured using a pH meter (Mettler Toledo, seven compact). The accuracy was ±0.002, and the measurement was performed at room temperature.

In the case of capturing CO₂ with aqueous amine solutions, the use of new solvents to make up for the lost amine diminishes the cost-effectiveness of the process. As the vapor pressure of the capture agent is lower, CO₂ is maintained in the liquid state more favorably and less volatilized into the gaseous state, and this makes the process more efficient. Therefore, the measured vapor pressure of aqueous amine solution provides important information in the CO₂ capture process and can be utilized to improve the efficiency and safety of the process. An automatic vapor pressure tester (GRABNER INSTRUMENTS, MiniVap VP Vision) was used to measure the vapor pressure. The vapor pressure was continuously measured in the temperature range of 313 to 393 K.

All physicochemical properties were measured three times and the averages of the measured values were calculated to obtain reliable results.

The physicochemical properties of the capture agent can be applied as important parameters for design in the CO₂ capture process. Table 2 is summarized data of the measured values of density, viscosity, pH, vapor pressure, and specific heat depending on the composition of 3DMA1P+PZ system in the present invention. As the content of PZ increased, the density and viscosity increased. The pH tended to increase as the PZ content increased, which indicates that the capture agent has a stronger basicity and is protonated more quickly to make the reaction rate with CO₂ can become faster as the amount of PZ increases [34]. Based on the pH analysis results, this can be a piece of data that can verify the results of the overall mass transfer experiment conducted earlier. The vapor pressure tended to decrease as the PZ content increased at both 313 K and 393 K. From the VLE experiment results, it can be seen that the CO₂ loading (mol_{CO}_{₂}/molₐₘᵢₙₑ) value, which is not greatly different at 313 K, is significantly different at 393 K, so the effect of vapor pressure cannot be ignored. In the measurement results of specific heat, the single 3DMA1P 40 had the lowest value, mixed capture agents containing PZ had higher values than the single 3DMA1P 40, and the 3DMA1P 30+PZ 10 mixed capture agent, which had the highest PZ content, had the lowest value among these.

TABLE 2

| | | Viscosity | | | | Vapor | | Specific |
|---|---|---|---|---|---|---|---|---|
| | Density | (mPa · s, 313K) | | pH | | pressure | | heat |
| Absorbent | (g/cm³, | | CO₂ | | CO₂ | (kPa) | | capacity |
| (% by weight) | 298K) | Fresh | loaded | Fresh | loaded | 313K | 393K | (kJ/kg · K) |
| 3DMA1P 40 | 0.969 | 3.68 | 5.32 | 11.57 | 9.01 | 6.35 | 97.98 | 2.19 |
| 3DMA1P 37.5 + | 0.972 | 3.79 | 5.9 | 11.72 | 8.67 | 6.25 | 97.08 | 3.20 |
| PZ 2.5 | | | | | | | | |
| 3DMA1P 35 + PZ | 0.976 | 3.96 | 6.35 | 11.81 | 8.58 | 6.22 | 96.93 | 3.47 |
| 5 | | | | | | | | |
| 3DMA1P 32.5 + | 0.979 | 4.1 | 6.71 | 11.92 | 8.43 | 6.22 | 96.48 | 3.24 |
| PZ 7.5 | | | | | | | | |
| 3DMA1P 30 + PZ | 0.982 | 4.24 | 6.91 | 11.95 | 8.34 | 6.13 | 95.8 | 2.79 |
| 10 | | | | | | | | |

The foregoing description of the present invention is for illustrative purposes only, and those skilled in the art to which the present invention pertains will understand that the present invention can be easily modified into other specific forms without changing its technical idea or essential features. Therefore, the embodiments described above should be understood in all respects as illustrative and not restrictive. For example, each component described as single may be implemented in a distributed manner, and similarly, components described as distributed may also be implemented in a combined form.

The scope of the present invention is indicated by the claims described below, and all changes or modified forms derived from the meaning and scope of the claims and their equivalent concepts should be construed as being included in the scope of the present invention.

According to an embodiment of the present invention, the carbon dioxide capture agent not only enables an effective and economically sustainable CO₂ capture process but also can have a more advantageous effect in terms of reaction rate.

The effects of the present invention are not limited to the effects described above, and should be understood to include all effects that can be inferred from the configuration of the invention described in the detailed description or claims of the present invention.

While the present invention has been described with respect to the specific embodiments, it will be apparent to those skilled in the art that various changes and modifications may be made without departing from the spirit and scope of the invention as defined in the following claims.

What is claimed is:

1. A carbon dioxide capture agent comprising an amine mixture,
wherein the amine mixture contains a first amine compound including a tertiary amine; and a second amine compound including a secondary amine.

2. The carbon dioxide capture agent according to claim 1,
wherein the first amine is one or more selected from the group consisting of 3-dimethylamino-1-propanol (3DMA1P), N, N-methyl diethanolamine (MDEA), triethanolamine (TEA), triisopropanolamine (TIPA), and any combination thereof.

3. The carbon dioxide capture agent according to claim 1,
wherein the first amine is 3-dimethylamino-1-propanol (3DMA1P).

4. The carbon dioxide capture agent according to claim 1,
wherein the second amine is one or more selected from the group consisting of piperazine (PZ), propylamine, dipropylamine, butylamine, dibutylamine, isobutylamine, 1,2-dimethyl propylamine, hexylamine, N,N-dimethyl allylamine, dimethylamino ethylamine, 1,3-diamino propane, methylamino propylamine, N-aminoethyl morpholine, iminobispropylamine, 2-pipecoline, 2,4-lupetidine, N-amino-4-pipecoline, 2-piperidine ethanol, 4-piperidinol, N-methyl benzylamine, dibenzylamine, phenethylamine, pyrazine, 2-methyl pyrazine, 2-methyl piperazine, 2,3-lutidine, 2-methyl-4-ethyl pyridine, 4-alkyl pyridine, picolinic acid, 2-aminonicotinic acid, 3-amino pyridine, 3-decyloxy propylamine, and any combination thereof.

5. The carbon dioxide capture agent according to claim 1,
wherein the second amine is piperazine (PZ).

6. The carbon dioxide capture agent according to claim 1,
wherein the amine mixture contains the first amine compound and the second amine compound at a weight ratio of 2 to 15:1.

7. The carbon dioxide capture agent according to claim 1,
wherein a content of the amine mixture is 35% to 45% by weight based on 100% by weight of a total amount of the carbon dioxide capture agent.

8. A carbon dioxide capture method comprising:
preparing a liquid absorbent containing an amine mixture;
bringing the liquid absorbent into contact with a gas or liquid containing carbon dioxide;
absorbing carbon dioxide from the gas or liquid; and
desorbing the carbon dioxide,
wherein the amine mixture contains a first amine compound including a tertiary amine and a second amine compound including a secondary amine.

9. The carbon dioxide capture method according to claim 8,
wherein the first amine is 3-dimethylamino-1-propanol (3DMA1P), and
the second amine is piperazine (PZ).

10. The carbon dioxide capture method according to claim 8,
wherein the amine mixture contains the first amine compound and the second amine compound at a weight ratio of 2 to 15:1.

11. The carbon dioxide capture method according to claim 8,
wherein a content of the amine mixture is 35% to 45% by weight based on 100% by weight of a total amount of the liquid absorbent.

12. The carbon dioxide capture method according to claim 8,
wherein the absorption step is performed at a temperature of 300 to 330 K.

13. The carbon dioxide capture method according to claim 8,
wherein the absorption step is performed at a pressure of 1 to 10 kPa.

14. The carbon dioxide capture method according to claim 8,
wherein the desorption step is performed at a temperature of 380 to 410 K.

15. The carbon dioxide capture method according to claim 8,
wherein the desorption step is performed at a pressure of 90 to 100 kPa.
